(19) United States
(12) Patent Application Publication
(10) Pub. No.: US 2025/0150942 A1
(43) Pub. Date: May 8, 2025

(54) FLEXIBLE BEACON INTERVALS IN A WIRELESS NETWORK

(71) Applicant: QUALCOMM Incorporated, San Diego, CA (US)

(72) Inventors: Alfred Asterjadhi, San Diego, CA (US); George Cherian, San Diego, CA (US); Abhishek Pramod Patil, San Diego, CA (US); Gaurang Naik, San Diego, CA (US); Sai Yiu Duncan Ho, San Diego, CA (US); Guido Robert Frederiks, Watsonville, CA (US)

(21) Appl. No.: 18/502,946

(22) Filed: Nov. 6, 2023

(51) Int. Cl. H04W 48/12; H04W 48/16

(52) U.S. Cl. CPC H04W 48/12; H04W 48/16

(57) ABSTRACT

This disclosure provides methods, components, devices and systems for flexible beacon interval operation. Some aspects more specifically relate to inclusion of indications of static and dynamic beacon intervals in beacon frames, and other frames. In some examples, an AP may transmit a frame including multiple indications of multiple beacon intervals, such as an indication of a static beacon interval and an indication of a dynamic beacon interval. The AP may then transmit frames, such as beacon frames, at times associated with the beacon intervals.

### TECHNICAL FIELD

This disclosure relates generally to wireless communication, and more specifically, to support for flexible beacon intervals in a wireless network.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Beacon frames transmitted by an AP to one or more STAs within wireless range of the AP may be transmitted at a regular interval, referred to as a beacon interval. Such an interval may, for example, be set when a BSS associated with the beacon frames is established by the AP. Use of such a beacon interval for transmission of beacon frames associated with a BSS may allow STAs to predict when beacon frames associated with a BSS will be transmitted by an AP.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus for wireless communication at an access point (AP). The apparatus includes a processing system a processing system that includes processor circuitry and memory circuitry that stores code, the processing system configured to cause the apparatus to: transmit a first frame comprising a first indication of a first beacon interval and a second indication of a second beacon interval, transmit a second frame at a first time associated with the first indication, and transmit a third frame at a second time associated with the second indication.

In some examples, the first indication includes a static beacon interval indication and the second indication includes a dynamic beacon interval indication. In some examples, the first frame includes a third indication of an update to the second beacon interval.

Another innovative aspect of the subject matter described in this disclosure can be implemented in a method for wireless communication at an AP. The method includes transmitting a first frame comprising a first indication of a first beacon interval and a second indication of a second beacon interval, transmitting a second frame at a first time associated with the first indication, and transmitting a third frame at a second time associated with the second indication.

Another innovative aspect of the subject matter described in this disclosure can be implemented in an apparatus for wireless communications at a station. The apparatus includes a processing system that includes processor circuitry and memory circuitry that stores code, the processing system configured to cause the apparatus to: receive, from an access point, a first frame comprising a first indication of a first beacon interval and a second indication of a second beacon interval and receive, from the access point, a second frame at a first time associated with the second indication.

Another innovative aspect of the subject matter described in this disclosure can be implemented in a method for wireless communication at a station. The method includes receiving, from an access point, a first frame comprising a first indication of a first beacon interval and a second indication of a second beacon interval and receiving, from the access point, a second frame at a first time associated with the second indication.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a pictorial diagram of another example wireless communication network 500.

FIG. 6 shows a timing diagram of frames transmitted by an AP that supports flexible beacon interval operation.

FIG. 7 shows a flowchart illustrating an example process performable by or at a wireless AP that supports flexible beacon interval operation.

FIG. 8 shows a flowchart illustrating an example process performable by or at a wireless AP that supports flexible beacon interval operation.

FIG. 9 shows a flowchart illustrating an example process performable by or at a wireless AP that supports flexible beacon interval operation.

FIG. 10 shows a flowchart illustrating an example process performable by or at a wireless STA that supports flexible beacon interval operation.

FIG. 11 shows a flowchart illustrating an example process performable by or at a wireless STA that supports flexible beacon interval operation.

FIG. 12 shows a flowchart illustrating an example process performable by or at a wireless STA that supports flexible beacon interval operation.

FIG. 13 shows a block diagram of an example wireless communication device that supports flexible beacon interval operation.

FIG. 14 shows a block diagram of an example wireless communication device that supports flexible beacon interval operation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless communication and more particularly to flexible beacon interval operation. Some aspects more specifically relate to use of flexible beacon intervals for transmission of beacon frames by an AP. In some examples, an AP may transmit a frame, such as a beacon frame, a probe response frame, an association response frame, an authentication response frame, or other frame, including a first indication of a first beacon interval and a second indication of a second beacon interval. The AP may then transmit frames, such as beacon frames, in accordance with the first and second indications of the first and second intervals. The first beacon interval may be static, to allow the AP to communicate with STAs that support static beacon intervals, and the other may be dynamic, to allow for dynamic adjustment of the beacon interval. In some aspects, the second beacon interval may be defined in relation to the first beacon interval. For example, the second beacon interval may be a multiple of the first beacon interval. In some examples, the first frame may include an indication of an update to the second beacon interval. For example, the first frame may include an indication of a current value of the second beacon interval and an indication of an updated value for the second beacon interval. In some aspects, the first frame may further include an indication of when the second beacon interval will be updated from the first value to the second value, such as a counter indicating a time at which the AP will transmit a beacon frame in accordance with the update to the second beacon interval. A transmit time period for transmission of beacon frames may be similarly updated. Thus, a frame, such as a beacon frame, may include multiple indications of multiple beacon intervals, information regarding updates to the beacon intervals, and other information related to beacon intervals, and beacon frames may be transmitted at times associated with the indicated beacon intervals.

Particular aspects of the subject matter described in this disclosure can be implemented to realize one or more of the following potential advantages. Inclusion of multiple beacon interval indications in a frame may allow an AP to support communication with STAs that do not support dynamic beacon intervals while also supporting use of dynamic beacon intervals in communicating with STAs that do support dynamic beacon intervals. Support of dynamic beacon intervals, such as updates to beacon intervals, may enhance network efficiency, allowing an AP to better adapt to changes in downlink traffic. For example, network efficiency may be enhanced through decreasing a beacon interval during periods when downlink traffic is high. As another example, dynamic beacon intervals may allow for enhanced adaptability to discoverability and wireless medium conditions. For example, a beacon interval may be increased if an AP is not interested in being discovered quickly, is relying on active scanning for discovery, or if the wireless medium is busy with other traffic. As another example, use of dynamic beacon intervals may allow for reduced power usage, as a beacon interval may be increased during periods of low BSS utilization to reduce power consumption. As another example, use of flexible beacon intervals may allow an AP to refrain from transmitting beacon frames following a dynamic beacon interval if there are no STAs associated with the AP that support dynamic beacon intervals, reducing AP power usage and transmission pollution. Similarly, use of flexible beacon intervals may allow an AP to begin or resume transmitting beacon frames using dynamic beacon intervals when a STA that supports dynamic beacon intervals is determined to be within a predetermined range of the AP, such as when the AP has been discovered by the STA via active scanning. Thus, inclusion of multiple beacon interval indications in a frame may allow for support of a wide range of device configurations, and use of dynamic beacon intervals may allow for enhanced adaptability in network resource usage and reduced power consumption.

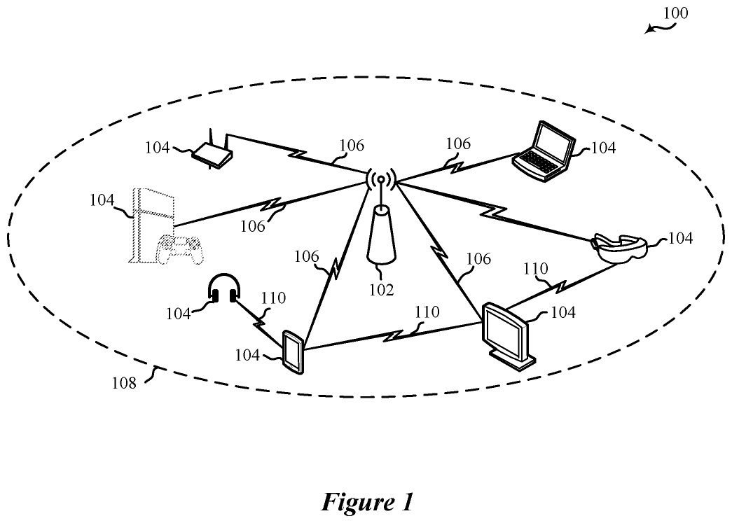

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

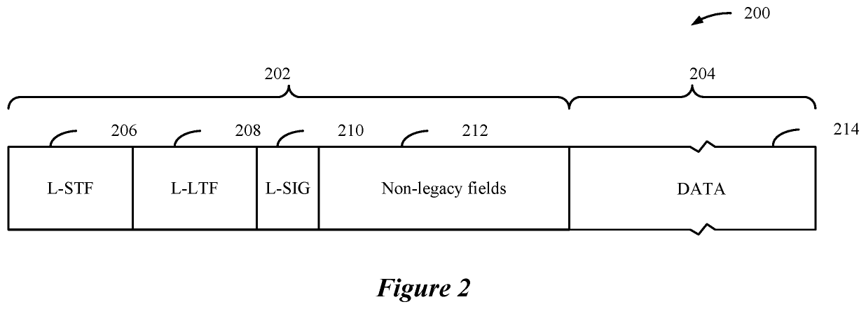

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as AP 102 or STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

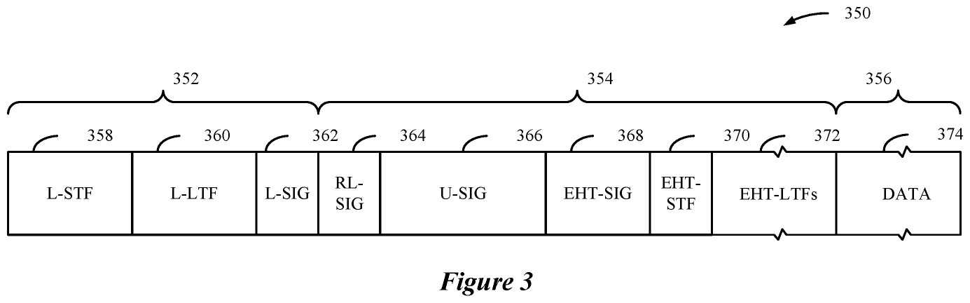

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

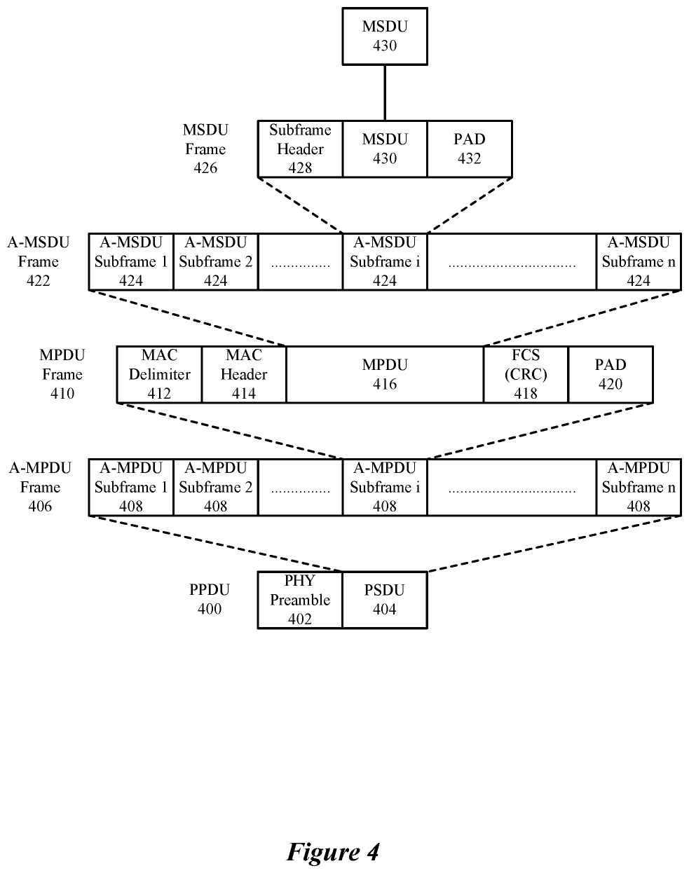

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some wireless communication devices (including both APs and STAs such as, for example, AP 102 and STAs 104 described in FIG. 1) are capable of multi-link operation (MLO). In some examples, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). An MLD may include a single upper MAC layer, and can include, for example, three independent lower MAC layers and three associated independent PHY layers for respective links in the 2.4 GHz, 5 GHz, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and QoS characterization, which achieves latency reduction and other QoS enhancements by mapping traffic flows having different latency or other requirements to different links. For example, traffic with low latency requirements can be mapped to wireless links operating in the 6 GHz band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

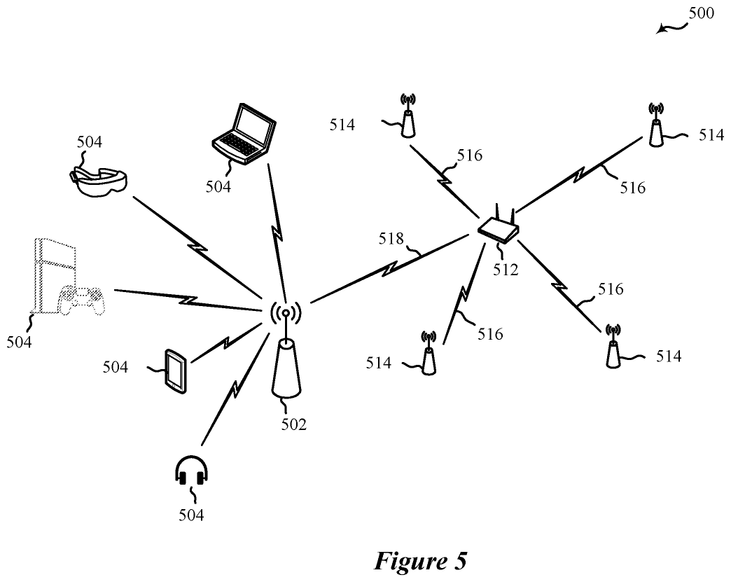

FIG. 5 shows a pictorial diagram of another example wireless communication network 500. According to some aspects, the wireless communication network 500 can be an example of a mesh network, an IoT network or a sensor network in accordance with one or more of the IEEE 802.11 family of wireless communication protocol standards (including the 802.11ah amendment). The wireless network 500 may include multiple wireless communication devices 514. The wireless communication devices 514 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 514 sense, measure, collect or otherwise obtain and process data and then transmit such raw or processed data to an intermediate device 512 for subsequent processing or distribution. Additionally or alternatively, the intermediate device 512 may transmit control information, digital content (for example, audio or video data), configuration information or other instructions to the wireless communication devices 514. The intermediate device 512 and the wireless communication devices 514 can communicate with one another via wireless communication links 516. In some examples, the wireless communication links 516 include Bluetooth links or other PAN or short-range communication links.

In some examples, the intermediate device 512 also may be configured for wireless communication with other networks such as with a Wi-Fi WLAN 100 or a wireless (for example, cellular) wide area network (WWAN), which may, in turn, provide access to external networks including the Internet. For example, the intermediate device 512 may associate and communicate, over a Wi-Fi link 518, with an AP 502 of a WLAN network, which also may serve various STAs 504. In some examples, the intermediate device 512 is an example of a network gateway, for example, an IoT gateway. In such a manner, the intermediate device 512 may serve as an edge network bridge providing a Wi-Fi core backhaul for the IoT network including the wireless communication devices 514. In some examples, the intermediate device 512 can analyze, preprocess and aggregate data received from the wireless communication devices 514 locally at the edge before transmitting it to other devices or external networks via the Wi-Fi link 518. The intermediate device 512 also can provide additional security for the IoT network and the data it transports.

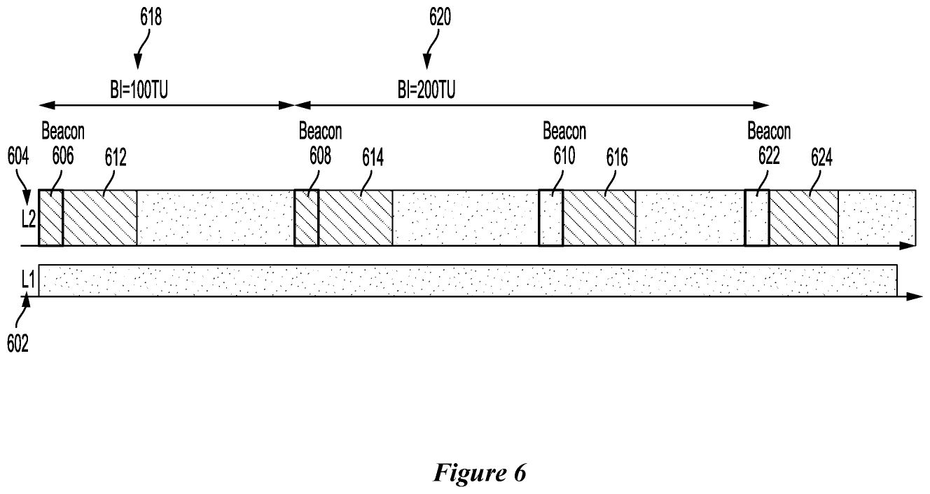

FIG. 6 shows a timing diagram 600 of frames transmitted by an AP that supports flexible beacon interval operation. In some aspects, the AP may be an AP of an MLD communicating with STAs on a first link 602 and a second link 604. The AP may, for example, communicate with STAs corresponding to a first BSS using the second link 604, and another AP of the MLD may communicate with STAs corresponding to a second BSS using the first link 602.

When establishing a BSS, such as a first BSS associated with the second link 604, the AP may assign a first beacon interval, such as beacon interval 618, at which the AP will transmit beacon frames associated with the BSS. The beacon interval 618 may, for example, be set to 100 time units (TUs), with each time unit being, for example, equal to 1024 microseconds. In some aspects, frames transmitted by the AP may include indications of the first beacon interval, such as indications that the first beacon interval is set to beacon interval 618, when establishing the BSS and subsequent to establishing the BSS. As one particular example, an AP, such as the first AP associated with the first BSS communicating using the second link 604, may transmit a frame, such as a PPDU as described with respect to FIG. 3, or a frame included in the data field 374 of a PPDU, as described with respect to FIG. 3, including a first indication of the first beacon interval, such as beacon interval 618. The frame including the indication of the first beacon interval may, for example, be or be included in a non-HT PPDU, an EHT PPDU, a VHT PPDU, an ultra high reliability (UHR) PPDU, or another format of PPDU. In some aspects, the frame may be a beacon frame, a probe response frame, an (re)association response frame, an authentication response frame, or another frame. A beacon interval established when initiating a BSS may remain static for the lifetime of the BSS. For example, the first beacon interval may be a static beacon interval set to beacon interval 618.

As one particular example, a first frame 606, such as a first beacon frame, may include an indication of a first beacon interval, which may be a static beacon interval set to the beacon interval 618. In some aspects, some STAs corresponding to the BSS may be configured to detect only beacon frames transmitted at the static beacon interval. The indication of the first beacon interval may, for example, be included in a beacon interval field of a beacon frame or another frame. A value of 0 in the beacon interval field may indicate that the AP has not set a beacon interval at which a next beacon frame will be transmitted. Values in the range of 1 to 65,535 in the beacon interval field may indicate the beacon interval in TUs. In addition to indicating a first beacon interval at which beacon frames may be transmitted, the frame 606, or an earlier transmitted frame, may also include an indication of a beacon transmission period 612. The beacon transmission period 612 may, for example, be a time period over which an AP will continue to attempt to send a beacon frame prior to ceasing attempts to transmit the beacon frame. For example, the AP may attempt to transmit the beacon frame 606 at a first time in accordance with the beacon interval until the beacon transmission period 612 has expired. After the beacon transmission period 612 has expired, a STA monitoring for transmission of the beacon frame 606 by the first AP may enter a low power state, such as a doze state, to save power. Thus, according to the static beacon interval, the AP may transmit beacon frames 606, 608, 610, and 622 at the first, static, beacon interval, set to the beacon interval 618, and STAs configured to monitor for beacon frames according to the static beacon interval may monitor for beacon frames 606, 608, 610, and 622.

To allow for flexibility in beacon interval timing over a lifetime of a BSS, a frame, such as a beacon frame, a probe response frame, an authentication response frame, or another frame may include an indication of a dynamic, or flexible, beacon interval that may be adjusted over the lifetime of the BSS. Use of a dynamic beacon interval may allow a beacon interval to be adjusted based on network conditions and traffic to enhance network efficiency and to reduce power consumption. As one particular example, the frame 606, which may be a beacon frame, may include an indication of a dynamic beacon interval set to the beacon interval 618. The indication of the dynamic beacon interval may, for example, be included in a legacy beacon interval field or in an additional dynamic beacon interval field, such as a UHR beacon interval field or another dynamic beacon interval field. In some examples, the frame 606 may include an indication of a single dynamic beacon interval, and in some examples the frame 606 may include an indication of a first, static, beacon interval and an indication of a second, dynamic, beacon interval. In some aspects, the indication of the dynamic beacon interval may include an indication of a beacon interval value, such as a value of 1-65,535 described with respect to the beacon interval field herein. In some aspects, the indication of the dynamic beacon interval, if included in a separate field from a static beacon interval, may be defined in relation to the indication of the static beacon interval. For example, a beacon interval scaling factor may be included indicating a division or multiplication factor for the static beacon interval for determination of the dynamic beacon interval. That is, the dynamic beacon interval field may include an indication that the dynamic beacon interval is 0.25, 0.5, 1, 2 or another multiple of the static, or legacy, beacon interval indicated in the beacon interval field. In the example of FIG. 6, the dynamic beacon interval field may indicate that the dynamic beacon interval, at frame 606, is 1×, or equal to, the static beacon interval.

Use of longer beacon intervals for the dynamic beacon interval may reduce beacon pollution and power consumption through transmission of fewer beacon frames. In some examples, a dynamic beacon interval value may be set to 0 to place an AP in beacon-less mode. Use of shorter beacon intervals may reduce downlink traffic indication message (TIM) delivery indications, with receiving STAs waking more frequently to detect if there are pending transmissions from the transmitting AP.

To facilitate flexibility of the dynamic beacon interval, the frame 606 may include an indication of an update to the dynamic beacon interval. In some aspects, an indication of an update to a dynamic beacon interval may be included several frames in advance of implementation of the update to the dynamic beacon interval to allow time for STAs to be notified of the change to the dynamic beacon interval. For example, in addition to an indication of a dynamic beacon interval and an indication of a static beacon interval, the frame 606 may include an indication of an update to the dynamic beacon interval, such as a new value for the dynamic beacon interval and/or a new multiple of the static beacon interval that should be applied to determine the updated dynamic beacon interval. As a particular example, the frame 606 may include an indication that the dynamic beacon interval is currently set to the beacon interval 618 and an indication that the dynamic beacon interval should be updated to the beacon interval 620, having a length of 200 TUs.

In some aspects, a frame may include, in addition to an indication of a current dynamic beacon interval and an update to the current dynamic beacon interval, an indication of when the update to the dynamic beacon interval will be implemented. For example, the first frame 606 may include a counter or other indicator indicating that the update to the dynamic beacon interval will be implemented after beacon 608, with a beacon interval between beacon frames transmitted according to the dynamic beacon interval increasing to 200 TUs for transmission of the beacon frame 622. In some aspects, the indication of when the update to the dynamic beacon interval will be implemented may include a counter of one or more delivery traffic indication message (DTIM) intervals between receipt of the frame including the indication of when the update will be implemented and the update being implemented. Thus, beacon frames may, for example, include counters indicating when the update to the dynamic beacon interval will be implemented. In some aspects, including an indication of when the update to the dynamic beacon interval will be implemented may allow a STA to request that the update to the dynamic beacon interval not be implemented or to request that the static beacon interval be used for the STA.

Thus, an AP associated with a BSS on the second link 604 may transmit a beacon frame 604 including an indication that a static beacon interval is set to the beacon interval 618, an indication that a dynamic beacon interval is set to the beacon interval 618, an indication of an update to the dynamic beacon interval to the beacon interval 620, and an indication that the update to the dynamic beacon interval will be implemented at the beacon frame 608. A STA that does not support the dynamic beacon interval may receive the beacon frame 606 and may expect beacon frames 608, 610, and 622 at intervals associated with the static beacon interval, and a STA that supports the dynamic beacon interval may receive the beacon frame 606 and may expect the beacon frame 608 to be transmitted in accordance with the current flexible beacon interval and the beacon frame 622 to be transmitted in accordance with the update to the dynamic beacon interval. The AP may then transmit beacon frames 608, 610, and 622 in accordance with the static beacon interval and beacon frames 608 and 622 in accordance with the dynamic beacon interval and the update to the dynamic beacon interval. The AP may transmit the beacon frame 606 for the beacon transmission period 612, the beacon frame 608 for the beacon transmission period 614, the beacon frame 610 for the beacon transmission period 616, and the beacon frame 622 for the beacon transmission period 624. In some aspects, such as when beacon frames transmitted according to a dynamic beacon interval are transmitted more frequently than beacon frames transmitted according to a static beacon interval, such beacon frames may include additional information for particular STAs, such as UHR STAs, not present in beacon frames that are transmitted according to the static beacon interval. Such additional information may include UHR operation information elements, UHR capabilities information elements, and other information elements. In some aspects, such as when beacon frames transmitted according to a dynamic beacon interval are transmitted more frequently than beacon frames transmitted according to a static beacon interval, beacon frames that do not align with the static beacon interval may include only information for STAs configured to support dynamic beacon intervals, such as only information for UHR STAs, as legacy STAs may not wake for or decode beacon frames not transmitted according to the static beacon interval.

Similarly, an indication of an update to a beacon transmission period 612 and an indication of when an update to the beacon transmission period 612 will be implemented may also be included in the frame 606. In some aspects, the frame 606 may include an indication of a static beacon transmission period, an indication of a dynamic beacon transmission period, an indication of an update to the dynamic beacon transmission period, and an indication of a time at which the update to the dynamic beacon transmission period will be implemented similar to the indications for the dynamic beacon interval described herein. Thus, the beacon transmission periods 614, 616, 624 may be updated according to updates to beacon transmission periods as discussed herein.

Thus, to maintain backwards compatibility, a frame, such as a beacon frame or other frame, may include indications of multiple beacon intervals, such as an indication of a first, static, beacon interval for communication with STAs that do not support dynamic beacon intervals, such as legacy STAs, and a second, flexible, beacon interval for communication with STAs that do support dynamic beacon intervals, such as UHR STAs. In some aspects, non-legacy or UHR STAs may continue to monitor for beacon frames according to a static or legacy beacon interval if they are configured to operate in a legacy power saving mode. Furthermore, to provide flexibility, a frame may include indications of updates to beacon intervals and/or beacon transmission periods and times at which updates to beacon intervals and/or beacon transmission periods will be implemented.

In some aspects, another AP of the same MLD associated with the first link 602 may also transmit a frame, such as a beacon frame or other frame, including an indication of the dynamic beacon interval for the second link 604, an indication of an update to the dynamic beacon interval for the second link 604, and/or an indication of a time at which the update to the dynamic beacon interval for the second link 604 will be implemented. Such indications may be included in a reduced neighbor report element, a neighbor report element, a multi-link element, or another element of a frame transmitted by an AP on the first link 602. Transmission of such indications by another AP of the same MLD on another link may allow the other AP to notify STAs corresponding to another BSS of updates to beacon intervals and/or beacon transmission periods, to facilitate discovery of the AP associated with the second link 604 by the other STAs. Similarly, dynamic beacon intervals for the first link 602 may be updated by the other AP associated with the first link 602, and such updates may be advertised by the AP associated with the second link 604 in beacon frames, probe response frames, or other frames. In some aspects, an update to a beacon interval by a first AP of an MLD on a first link may be signaled by one or more other APs of the MLD on other links using one or more critical update parameters such as a critical update flag, one or more countdown values indicating when one or more updates to one or more dynamic beacon intervals on other links will be implemented, and other update parameters. As another example, such updates may be signaled by adding a static beacon interval indication, such as a legacy beacon interval indication, a dynamic beacon interval indication, such as a UHR beacon interval indication, an indication of an update to the dynamic beacon interval, and/or an indication of when the update to the dynamic beacon interval will be implemented to one or more per STA profiles associated with the APs and/or links that are being advertised, such as in a multi-link information element. As another example, such updates may be signaled by adding such information to a reduced neighbor report, such as to a next target beacon transmission time (TBTT) information element.

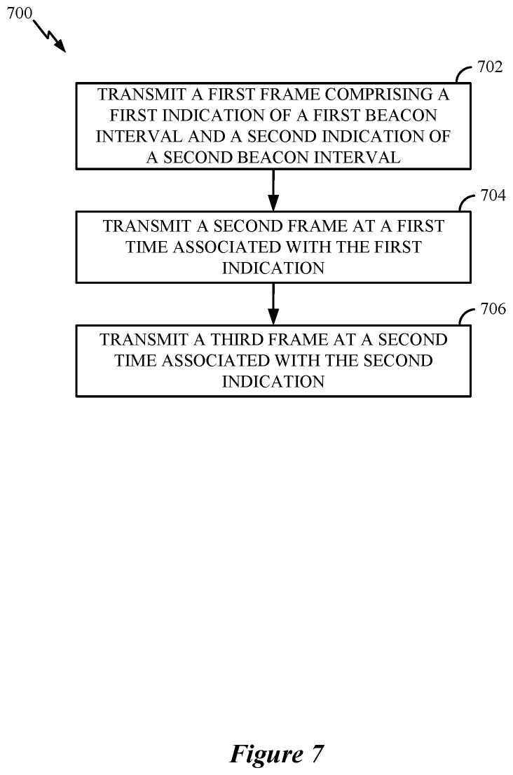

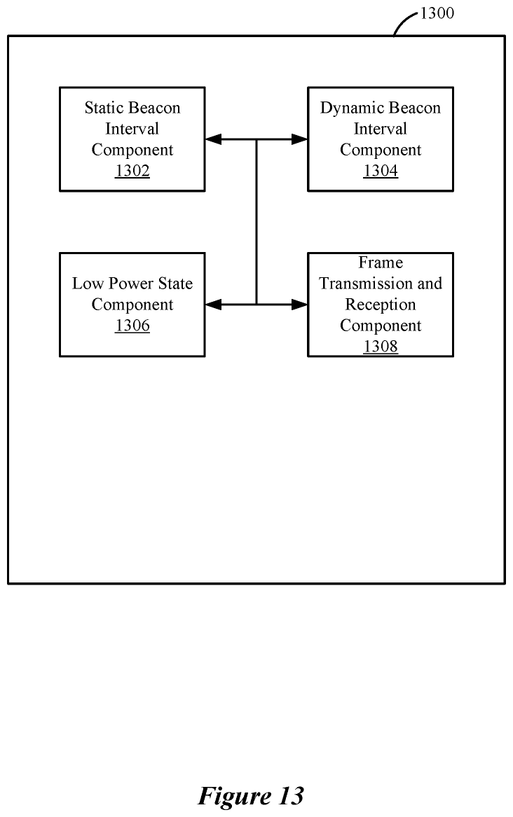

FIG. 7 shows a flowchart illustrating an example process 700 performable by or at a wireless AP that supports flexible beacon interval operation. The operations of the process 700 may be implemented by a wireless AP or its components as described herein. For example, the process 700 may be performed by a wireless communication device, such as the wireless communication device 1300 described with reference to FIG. 13, operating as or within a wireless AP. In some examples, the process 700 may be performed by a wireless AP such as one of the APs 102 described with reference to FIG. 1.

In some examples, in block 702, the wireless AP may transmit a first frame comprising a first indication of a first beacon interval and a second indication of a second beacon interval. Use of two beacon intervals may provide flexibility in beacon interval signaling. For example, different beacon intervals may be used for different STAs that support different beacon features. The first frame may, for example, be a beacon frame, a probe response frame, an association response frame, an authentication response frame, or another frame type. In some aspects, the first frame may be or may be included in a PPDU, such as a VHT PPDU, an HE PPDU, a UHR PPDU, an EHT PPDU, or another type of PPDU. The first indication of the first beacon interval may, for example, be an indication of a static beacon interval, such as a legacy beacon interval, and the second indication of the second beacon interval may be an indication of a dynamic beacon interval. The static beacon interval may, for example, be a beacon interval that remains at a constant length during the existence of a BSS associated with the beacon interval, while the dynamic beacon interval may be adjusted by transmission of indications of adjustments to the dynamic beacon interval in frames, such as beacon frames or other frames. The first beacon interval may, for example, be used for transmission of beacon frames for STAs that do not support a dynamic beacon interval, such as legacy STAs, and the second beacon interval may be used for transmission of beacon frames for STAs that do support a dynamic beacon interval, such as UHR STAs. In some aspects, the first indication of the first beacon interval may be an indication of a length of the first beacon interval, such as a value from 1-65,535 that corresponds to a length of the second beacon interval in TUs. In some aspects, the second indication of the second beacon interval may be an indication of a length of the second beacon interval, such as a value from 1-65,535 that corresponds to a length of the second beacon interval in TUs. In some aspects, the second indication of the second beacon interval may be an indication of a multiple of the first beacon interval, such as a fraction of the first beacon interval or a 1×, 2×, or larger multiple of the first beacon interval. In some aspects, the first beacon interval and the second beacon interval may both correspond to a single BSS and a single link via which the AP communicates with one or more STAs.

In some aspects, in block 704, the wireless AP may transmit a second frame at a first time associated with the first indication. For example, the second frame may be a beacon frame, or other frame, transmitted in accordance with the first beacon interval. In some aspects, such as when the first beacon interval is a static beacon interval, the second frame may include information for STAs configured to operate according to a static beacon interval.

In some aspects, in block 706, the wireless AP may transmit a third frame at a second time associated with the second indication. For example, the third frame may be a beacon frame, or other frame, transmitted in accordance with the second beacon interval. In some aspects, such as when the second beacon interval is a dynamic beacon interval, the second frame may include information only for STAs configured to operate according to a dynamic beacon interval, such as UHR STAs.

In some aspects, the first frame may include a third indication of an update to the second beacon interval. For example, if the second beacon interval is a dynamic beacon interval, the second beacon interval may be dynamically updated by the AP. The indication of the update to the second beacon interval may include an indication of an updated value, such as an updated value from 1-65,535, or an indication of an updated multiple of the static beacon interval. The indication of the update to the second beacon interval may include an indication of a time at which the update to the second beacon interval will be implemented. For example, an indication of a time at which the update to the second beacon interval will be implemented may include a counter associated with the update to the second beacon interval indicating a time for transmission of a fourth frame, such as a beacon frame, associated with the update to the second beacon interval. As one particular example, the update to the dynamic beacon interval may be an update to a value of 0 for the dynamic beacon interval, such as when an AP has determined to cease transmission of beacon frames and/or when a last STA leaves a BSS associated with the beacon interval.

In some aspects, the first frame may further include an indication of an update to a beacon transmission period associated with the second beacon interval. For example, the first frame may include an indication of an update to an amount of time during which an AP will attempt to transmit beacon frames before ceasing transmission of beacon frames and entering a low power state.

In some aspects, the first frame may include an indication of an update to the first beacon interval. For example, the first frame may include multiple dynamic beacon intervals and multiple associated beacon interval updates.

In some aspects, the AP may be an AP of an MLD, associated with a first link of the MLD. The first frame may further include an indication of an update to a third beacon interval associated with a second AP of the MLD associated with a second link of the MLD. In some aspects, an indication of an update to the second beacon interval may further be transmitted in another frame transmitted by the second AP of the MLD associated with the second link of the MLD.

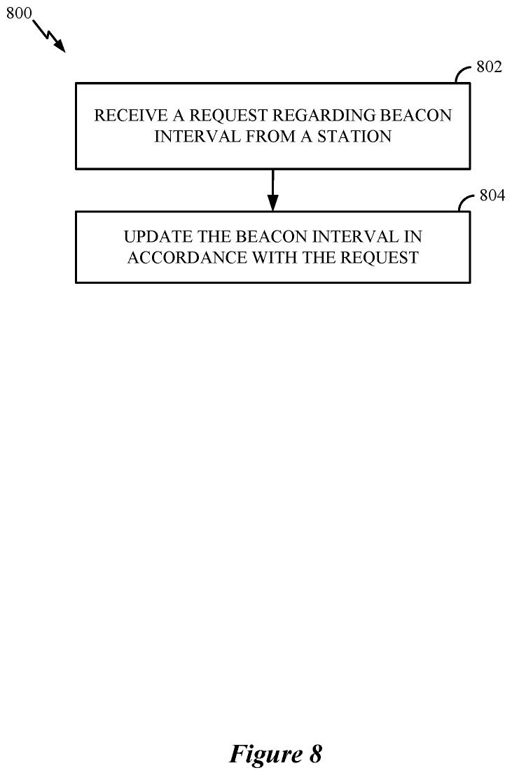

FIG. 8 shows a flowchart illustrating an example process 800 performable by or at a wireless AP that supports flexible beacon interval operation. The operations of the process 800 may be implemented by a wireless AP or its components as described herein. For example, the process 800 may be performed by a wireless communication device, such as the wireless communication device 1300 described with reference to FIG. 13, operating as or within a wireless AP. In some examples, the process 800 may be performed by a wireless AP such as one of the APs 102 described with reference to FIG. 1.

In some aspects, in block 802, the wireless AP may receive a request regarding a beacon interval from a station. The request regarding the beacon interval may, for example, be a request regarding the second beacon interval referenced with respect to the process 700 of FIG. 7. For example, the request may be a request regarding a dynamic beacon interval. In some aspects the request regarding the beacon interval may be transmitted by a STA and received by the AP in response to transmission of a frame including an indication of an update to a dynamic beacon interval by the AP. In particular, the request regarding the beacon interval may be a request to cancel an update to a beacon interval indicated in an earlier transmitted frame. As another example, the request regarding the beacon interval may include a request to update a dynamic beacon interval to a particular value. In some aspects, the request may include a request to update a beacon transmission period associated with a dynamic beacon interval.

In some aspects, in block 804, the wireless AP may update the beacon interval in accordance with the request. For example, if the request is a request to cancel an earlier indicated update to the beacon interval, the wireless AP may refrain from updating a beacon interval, such as a dynamic beacon interval, in association with the request. As another example, if the request is a request to update the beacon interval, such as a dynamic beacon interval, the AP may transmit a frame including an indication of the update to the beacon interval in accordance with receipt of the request at block 802. For example, the first frame described with respect to process 700 of FIG. 7 may be transmitted in response to such a request. As another example, if the request is a request to update a beacon transmission period associated with a dynamic beacon interval, the AP may adjust an amount of time for which beacon frame transmission is attempted and may include an indication of such an adjustment in a transmitted beacon, or other, frame. In some aspects, the AP may determine whether to update the beacon interval and/or transmit time attempt period only for the STA requesting the update or for a group of STAs, such as for all UHR STAs communicating with the AP. Thus, an AP and a STA may communicate to set a dynamic beacon interval at a value preferred by the AP and/or the STA.

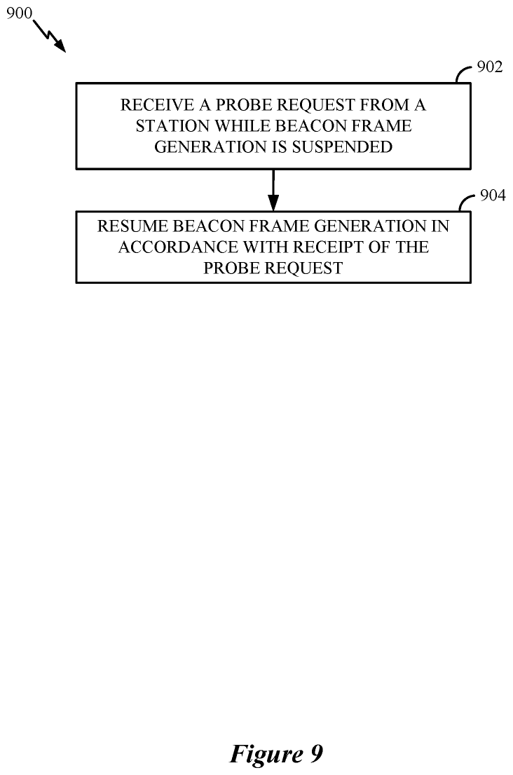

FIG. 9 shows a flowchart illustrating an example process 900 performable by or at a wireless AP that supports flexible beacon interval operation. The operations of the process 900 may be implemented by a wireless AP or its components as described herein. For example, the process 900 may be performed by a wireless communication device, such as the wireless communication device 1300 described with reference to FIG. 13, operating as or within a wireless AP. In some examples, the process 900 may be performed by a wireless AP such as one of the APs 102 described with reference to FIG. 1. In some aspects, the process 900 may be performed before the operations described with respect to the process 700 of FIG. 7.

In some aspects, in block 902, the AP may receive a probe request from a station while beacon frame generation is suspended. For example, the AP may be in a low power or sleep state and may not be transmitting beacon frames associated with one or more beacon intervals. As one particular example, the AP may refrain from transmitting beacons using a dynamic beacon interval when no STAs that support dynamic beacon intervals are associated with the AP. Upon receipt of a probe request from a STA that does support dynamic beacon intervals, or other indication that the STA is within range of the AP, the AP may resume transmission of beacon frames using the dynamic beacon interval, such as to support active scanning.

In some aspects, in block 904, the AP may resume beacon frame generation in accordance with receipt of the probe request. Such resumption may, for example, include transmission of a first frame as described with respect to block 702 of FIG. 7. Thus, the first frame of the process 700 may be transmitted in accordance with receipt of a probe request by the AP.

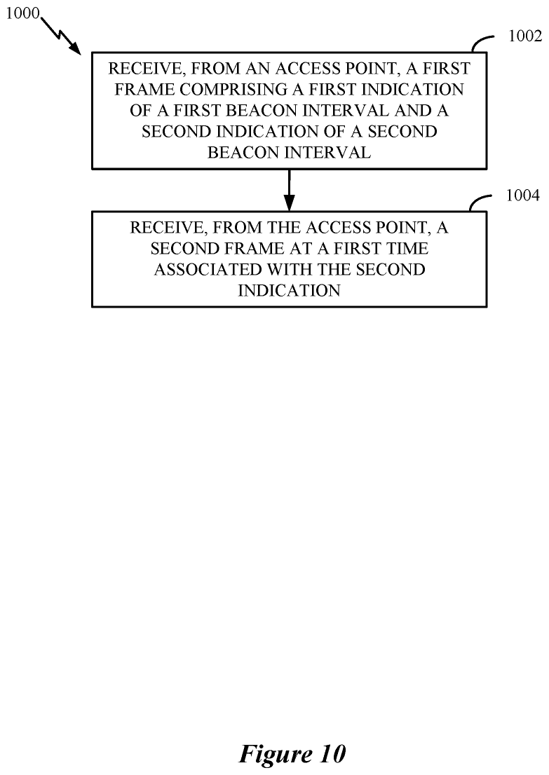

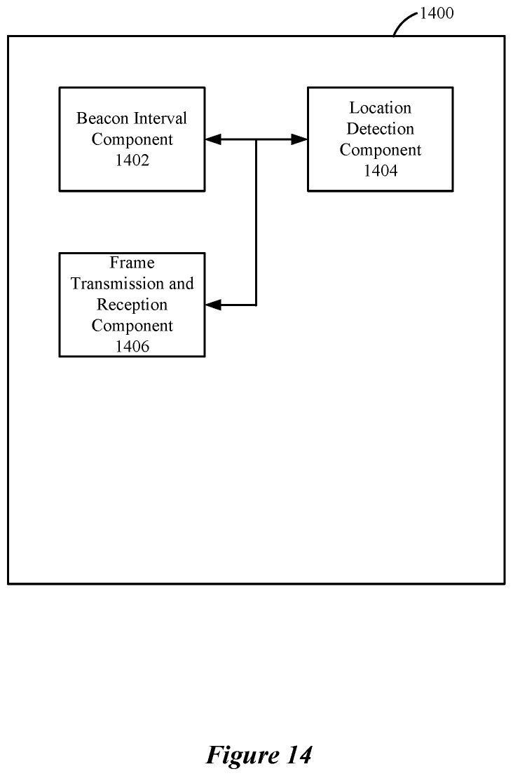

FIG. 10 shows a flowchart illustrating an example process 1000 performable by or at a wireless STA that supports flexible beacon interval operation. The operations of the process 1000 may be implemented by a wireless STA or its components as described herein. For example, the process 1000 may be performed by a wireless communication device, such as the wireless communication device 1400 described with reference to FIG. 14, operating as or within a wireless STA. In some examples, the process 1000 may be performed by a wireless STA such as one of the STAs 104 described with reference to FIG. 1.

In some examples, in block 1002, the wireless STA may receive, from an AP, a first frame comprising a first indication of a first beacon interval and a second indication of a second beacon interval. The first frame may, for example, be the same as or similar to the first frame described with respect to block 702 of FIG. 7. For example, the first beacon interval may be a static beacon interval and the second beacon interval may be a dynamic beacon interval.

In some examples, in block 1004, the wireless STA may receive, from the AP, a second frame at a first time associated with the second indication. For example, the wireless STA may be a STA configured to support dynamic beacon intervals, such as a UHR STA, and may monitor for a beacon frame transmitted by the AP at a time indicated by the second indication of the second beacon interval.

In some aspects, the wireless STA may receive a third frame at a second time associated with an update to the second beacon interval indicated by the first frame. For example, the first frame may include an indication of an update to the second beacon interval. The indication may, for example, include a counter associated with the update to the second beacon interval indicating a time for reception of the third frame associated with the update to the second beacon interval.

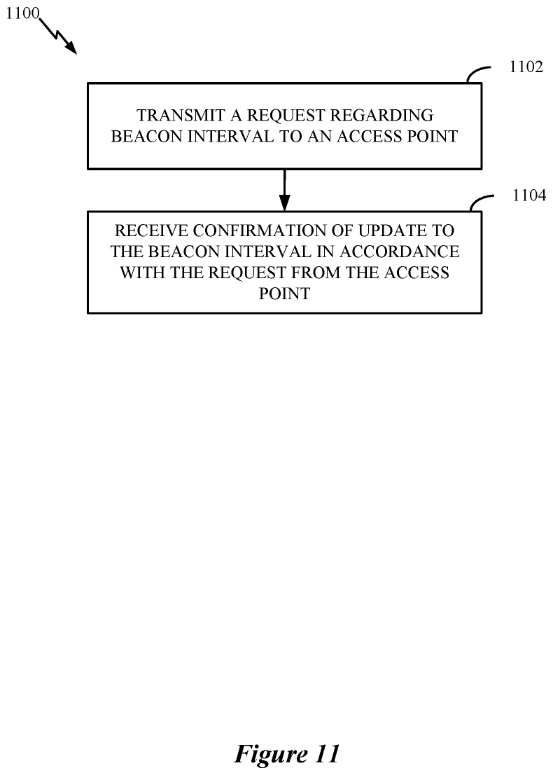

FIG. 11 shows a flowchart illustrating an example process 1100 performable by or at a wireless STA that supports flexible beacon interval operation. The operations of the process 1100 may be implemented by a wireless STA or its components as described herein. For example, the process 1100 may be performed by a wireless communication device, such as the wireless communication device 1400 described with reference to FIG. 14, operating as or within a wireless STA. In some examples, the process 1100 may be performed by a wireless STA such as one of the STAs 104 described with reference to FIG. 1.

In some examples, in block 1102, the wireless STA may transmit a request regarding a beacon interval to an access point. The request regarding the beacon interval may, for example, be a request regarding the second beacon interval referenced with respect to the process 1000 of FIG. 10. For example, the request may be a request regarding a dynamic beacon interval. In some aspects the request regarding the beacon interval may be transmitted in response to receipt of a frame including an indication of an update to a dynamic beacon interval by the STA. In particular, the request regarding the beacon interval may be a request to cancel an update to a beacon interval indicated in an earlier received frame. As another example, the request regarding the beacon interval may include a request to update a dynamic beacon interval to a particular value. The request may, for example, be a request to increase or decrease a dynamic beacon interval of the AP. In some aspects, the request may include a request to update a beacon transmission period associated with a dynamic beacon interval.

In some examples, in block 1104, the wireless STA may receive confirmation of an update to the beacon interval in accordance with the request from the access point. For example, if the request is a request to cancel an earlier indicated update to the beacon interval, the wireless AP may refrain from updating a beacon interval, such as a flexible beacon interval, in association with the request and may transmit confirmation that the beacon interval was not updated. As another example, if the request is a request to update the beacon interval, such as a dynamic beacon interval, the AP may transmit and the STA may receive a frame including an indication of the update to the beacon interval in accordance with receipt of the request at block 1102. For example, the first frame described with respect to process 1000 of FIG. 10 may be received in response to such a request. As another example, if the request is a request to update a transmit time attempt period associated with a dynamic beacon interval, the AP may adjust an amount of time for which beacon frame transmission is attempted and may include an indication of such an adjustment in a transmitted beacon frame, or other frame, received by the STA. Thus, an AP and a STA may communicate to set a dynamic beacon interval at a value preferred by the AP and/or the STA.

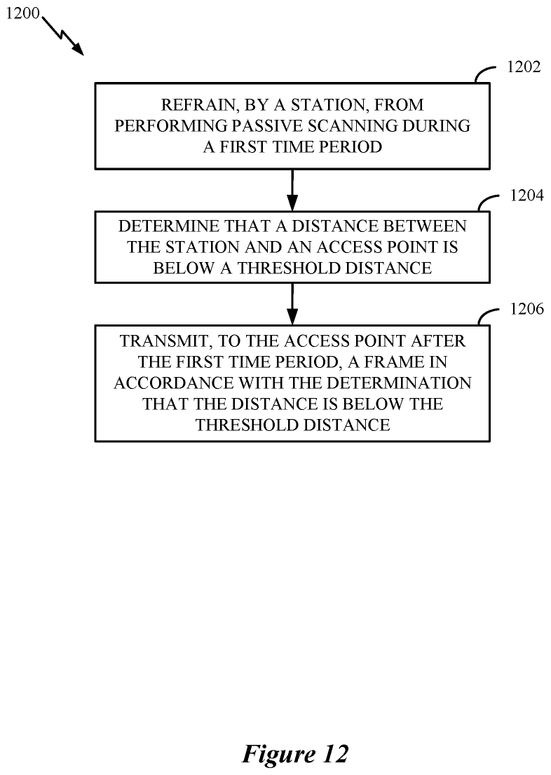

FIG. 12 shows a flowchart illustrating an example process 1200 performable by or at a wireless STA that supports flexible beacon interval operation. The operations of the process 1200 may be implemented by a wireless STA or its components as described herein. For example, the process 1200 may be performed by a wireless communication device, such as the wireless communication device 1400 described with reference to FIG. 14, operating as or within a wireless STA. In some examples, the process 1200 may be performed by a wireless STA such as one of the STAs 104 described with reference to FIG. 1.

In some examples, in block 1202, the wireless STA may refrain from performing passive scanning during a first time period. For example, the wireless STA may be in a sleep or low power state and may refrain from scanning for beacon and other frames transmitted by an AP while in the sleep or low power state.

In some examples, in block 1204, the wireless STA may determine that a distance between the STA and an AP is below a threshold distance. For example, the wireless STA may determine based on GPS, transmissions from the AP or other APs, such as through discovery of SSIDs or BSSIDs that are previously discovered at the same time as the AP, or other data, that the STA has entered within a predetermined range of the AP. The STA may, for example, determine that the STA may associate with the AP based on the determination that the STA has entered within the predetermined range of the AP.

In some examples, in block 1206, the wireless STA may transmit, to the AP after the first time period, a frame in accordance with the determination that the distance is below the threshold distance. The frame may, for example, be a probe request frame or other frame. The AP may, for example, be operating in a receive mode, such as an auxiliary receive (AUX RX) mode. Thus, the AP may only be able to receive particular frames, such as non-HT PPDUs or other frames. Upon receipt of the frame, such as the probe request frame, the AP may begin transmitting beacon frames and may resume normal operation, such as described with respect to block 904 of FIG. 9. As one particular example, the AP may be in a state of refraining from transmitting beacon frames using the dynamic beacon interval due to a lack of STAs that support dynamic beacon intervals associated with the AP. Upon receipt of the frame from the STA, the AP may begin or resume transmitting beacon frames using the dynamic beacon interval, such as to support active scanning. Thus, the STA may perform active scanning after the determination is made that the STA is within the predetermined distance of the AP. Such use of active scanning may be particularly useful in scenarios where the AP is configured to support dynamic beacon intervals, as the STA may not be aware of a beacon interval implemented by the AP.

FIG. 13 shows a block diagram of an example wireless communication device 1300 that supports flexible beacon interval operation. In some examples, the wireless communication device 1300 is configured to perform the process 700 described with reference to FIG. 7, the process 800 described with reference to FIG. 8, and/or the process 900 described with reference to FIG. 9. The wireless communication device 1300 may include one or more chips, SoCs, chipsets, packages, components or devices that individually or collectively constitute or comprise a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1300 may transmit the information output from the chip. In such an example, the second interface may refer to an interface between the processing system of the chip and a reception component, such that the device 1300 may receive information that is then passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in an AP, such as the AP 102 described with reference to FIG. 1. In some other examples, the wireless communication device 1300 can be an AP that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes a static beacon interval component 1302, a dynamic beacon interval component 1304, a low power state component 1306 and a frame transmission component 1308. Portions of one or more of the components 1302, 1304, 1306 and 1308 may be implemented at least in part in hardware or firmware. For example, the static beacon interval component 1302 may be implemented at least in part by a processor or a modem. In some examples, portions of one or more of the components 1302, 1304, 1306 and 1308 may be implemented at least in part by a processor and software in the form of processor-executable code stored in a memory.

The static beacon interval component 1302 is configurable or configured to determine a static beacon interval indication to be included in a frame.

The dynamic beacon interval component 1304 is configurable or configured to determine a dynamic beacon interval indication to be included in a frame and/or updates to a dynamic beacon interval indication to be included in a frame.

The low power state component 1306 is configurable or configured to place the AP 1300 in and wake the AP 1300 from a low power state, such as a state where the AP 1300 is not transmitting beacon frames.

The frame transmission and reception component 1308 is configurable or configured to transmit and receive frames, such as beacon frames, probe response frames, association response frames, and other frames including indications of static and dynamic beacon intervals and/or requests for updates associated with beacon intervals as described herein.

FIG. 14 shows a block diagram of an example wireless communication device 1400 that supports flexible beacon interval operation In some examples, the wireless communication device 1400 is configured to perform the process 1000 described with reference to FIG. 10, the process 1100 described with reference to FIG. 11, and/or the process 1200 described with reference to FIG. 12. The wireless communication device 1400 may include one or more chips, SoCs, chipsets, packages, components or devices that individually or collectively constitute or comprise a processing system. The processing system may interface with other components of the wireless communication device 1400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1400 may transmit the information output from the chip. In such an example, the second interface may refer to an interface between the processing system of the chip and a reception component, such that the device 1400 may receive information that is then passed to the processing system. In some such examples, the first interface also may obtain information, such as from the transmission component, and the second interface also may output information, such as to the reception component.

The processing system includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1400 can be configurable or configured for use in a STA, such as the STA 104 described with reference to FIG. 1. In some other examples, the wireless communication device 1400 can be a STA that includes such a processing system and other components including multiple antennas. The wireless communication device 1400 is capable of transmitting and receiving wireless communications in the form of, for example, wireless packets. For example, the wireless communication device 1400 can be configurable or configured to transmit and receive packets in the form of physical layer PPDUs and MPDUs conforming to one or more of the IEEE 802.11 family of wireless communication protocol standards. In some other examples, the wireless communication device 1400 can be configurable or configured to transmit and receive signals and communications conforming to one or more 3GPP specifications including those for 5G NR or 6G. In some examples, the wireless communication device 1400 also includes or can be coupled with one or more application processors which may be further coupled with one or more other memories. In some examples, the wireless communication device 1400 further includes a user interface (UI) (such as a touchscreen or keypad) and a display, which may be integrated with the UI to form a touchscreen display that is coupled with the processing system. In some examples, the wireless communication device 1400 may further include one or more sensors such as, for example, one or more inertial sensors, accelerometers, temperature sensors, pressure sensors, or altitude sensors, that are coupled with the processing system.

The wireless communication device 1400 includes a beacon interval component 1402, a location detection component 1404, and a frame transmission and reception component 1406. Portions of one or more of the components 1402, 1404, and 1406 may be implemented at least in part in hardware or firmware. For example, the beacon interval component 1402 may be implemented at least in part by a processor or a modem. In some examples, portions of one or more of the components 1402, 1404, and 1406 may be implemented at least in part by a processor and software in the form of processor-executable code stored in the memory.

The beacon interval component 1402 is configurable or configured to determine beacon intervals and updates to beacon intervals included in frames received from APs and/or to be included in requests transmitted to APs.

The low power mode component 1404 is configurable or configured to place the STA 1400 in and wake the STA 1400 from a low power state.

The location detection component 1406 is configurable or configured to determine a location of the STA 1400 in relation to one or more APs, as described herein.

The frame transmission and reception component 1408 is configurable or configured to receive frames including indications of beacon intervals and updates to beacon intervals from one or more APs and to transmit frames, such as frames including requests for updates to dynamic beacon intervals, to one or more APs, as described herein.

Implementation examples are described in the following numbered clauses:

1. An apparatus for wireless communication at an access point (AP), including: a processing system that includes processor circuitry and memory circuitry that stores code, the processing system configured to cause the apparatus to: transmit a first frame including a first indication of a first beacon interval and a second indication of a second beacon interval; transmit a second frame at a first time associated with the first indication; and transmit a third frame at a second time associated with the second indication.

2. The apparatus of clause 1, where the first indication comprises a static beacon interval indication and the second indication comprises a dynamic beacon interval indication.

3. The apparatus of clause 1, where the second indication comprises an indication of a multiple of the first beacon interval.

4. The apparatus of clause 1, where the first frame further comprises a third indication of an update to the second beacon interval.

5. The apparatus of clause 4, where the third indication comprises a counter associated with the update to the second beacon interval, the counter indicating a time for transmission of a fourth frame associated with the update to the second beacon interval.

6. The apparatus of clause 4, where the processing system is further configured to cause the apparatus to: receive a fifth frame from a station indicating a request to cancel the update to the second beacon interval; and refrain from updating the second beacon interval in association with the request.

7. The apparatus of clause 4, where the processing system is further configured to cause the apparatus to: receive, from a station, a request for an update to the second beacon interval, the first frame being transmitted in accordance with receipt of the request.

8. The apparatus of clause 1, where the AP is associated with a first link of a multi-link device (MLD), and the first frame further comprises a third indication of an update to a third beacon interval associated with a second link of the MLD.

9. The apparatus of clause 1, where the processing system is further configured to cause the apparatus to: receive a probe request from a station while the access point has suspended beacon frame generation; and resume beacon frame generation in accordance with receipt of the probe request, the first frame being transmitted in accordance with receipt of the probe request.

10. The apparatus of clause 1, where the first frame further comprises an indication of an update to a beacon transmission period associated with the second beacon interval.

11. A method for wireless communication at an access point (AP), including: transmitting a first frame including a first indication of a first beacon interval and a second indication of a second beacon interval; transmitting a second frame at a first time associated with the first indication; and transmitting a third frame at a second time associated with the second indication.

12. The method of clause 11, where the first indication comprises a static beacon interval indication and the second indication comprises a dynamic beacon interval indication.

13. The method of clause 11, where the second indication comprises an indication of a multiple of the first beacon interval.

14. The method of clause 11, where the first frame further comprises a third indication of an update to the second beacon interval.

15. The method of clause 14, where the third indication comprises a counter associated with the update to the second beacon interval, the counter indicating a time for transmission of a fourth frame associated with the update to the second beacon interval.

16. The method of clause 14, further including: receiving a fifth frame from a station indicating a request to cancel the update to the second beacon interval; and refraining from updating the second beacon interval in association with the request.

17. An apparatus for wireless communications at a station, including: a processing system that includes processor circuitry and memory circuitry that stores code, the processing system configured to cause the apparatus to: receive, from an access point, a first frame including a first indication of a first beacon interval and a second indication of a second beacon interval; and receive, from the access point, a second frame at a first time associated with the second indication.

18. The apparatus of clause 17, where the first indication comprises a static beacon interval indication and the second indication comprises dynamic beacon interval indication.

19. The apparatus of clause 17, where the first frame further comprises a third indication of an update to the second beacon interval, the third indication comprises a counter associated with the update to the second beacon interval, and the counter indicates a time for reception of a third frame associated with the update to the second beacon interval, from the access point.

20. The apparatus of clause 19, where the processing system is further configured to cause the apparatus to: transmit, to the access point, a fifth frame indicating a request to cancel the update to the second beacon interval.

21. The apparatus of clause 17, where the processing system is further configured to cause the apparatus to: transmit, to the access point, a request for an update to the second beacon interval, the first frame being received in accordance with receipt of the request by the access point.

22. The apparatus of clause 17, where the first frame further comprises an indication of an update to a beacon transmission period associated with the second beacon interval, and the processing system is further configured to cause the apparatus to: enter a low power state after the beacon transmission period has expired following a time associated with the second indication without receipt of a third frame associated with the second indication.

23. The apparatus of clause 17, where the processing system is further configured to cause the apparatus to: refrain from performing passive scanning during a first time period; determine a distance between the station and the access point is below a threshold distance; and transmit, to the access point after the first time period, a third frame in accordance with the determination that the distance between the station and the access point is below the threshold distance, the first frame being received in accordance with the third frame.

24. A method for wireless communication at a station, including: receiving, from an access point, a first frame including a first indication of a first beacon interval and a second indication of a second beacon interval; and receiving, from the access point, a second frame at a first time associated with the second indication.

25. The method of clause 24, where the first indication comprises a static beacon interval indication and the second indication comprises dynamic beacon interval indication.

26. The method of clause 24, where the first frame further comprises a third indication of an update to the second beacon interval, the third indication comprises a counter associated with the update to the second beacon interval, and the counter indicates a time for reception of a third frame associated with the update to the second beacon interval, from the access point.

27. The method of clause 26, further including: transmitting, to the access point, a fifth frame indicating a request to cancel the update to the second beacon interval.

28. The method of clause 24, further including: transmitting, to the access point, a request for an update to the second beacon interval, the first frame being received in accordance with receipt of the request by the access point.

29. The method of clause 24, where the first frame further comprises an indication of an update to a beacon transmission period associated with the second beacon interval, further including: entering a low power state after the beacon transmission period has expired following a time associated with the second indication without receipt of a third frame associated with the second indication.

30. The method of clause 24, further including: refraining from performing passive scanning during a first time period; determining a distance between the station and the access point is below a threshold distance; and transmitting, to the access point after the first time period, a third frame in accordance with the determination that the distance between the station and the access point is below the threshold distance, the first frame being received in accordance with the third frame.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at an access point (AP), comprising:
a processing system that includes processor circuitry and memory circuitry that stores code, the processing system configured to cause the apparatus to:
transmit a first frame comprising a first indication of a first beacon interval and a second indication of a second beacon interval;
transmit a second frame at a first time associated with the first indication; and
transmit a third frame at a second time associated with the second indication.

2. The apparatus of claim 1, wherein the first indication comprises a static beacon interval indication and the second indication comprises a dynamic beacon interval indication.

3. The apparatus of claim 1, wherein the second indication comprises an indication of a multiple of the first beacon interval.

4. The apparatus of claim 1, wherein the first frame further comprises a third indication of an update to the second beacon interval.

5. The apparatus of claim 4, wherein the third indication comprises a counter associated with the update to the second beacon interval, the counter indicating a time for transmission of a fourth frame associated with the update to the second beacon interval.

6. The apparatus of claim 4, wherein the processing system is further configured to cause the apparatus to:
receive a fifth frame from a station indicating a request to cancel the update to the second beacon interval; and
refrain from updating the second beacon interval in association with the request.

7. The apparatus of claim 4, wherein the processing system is further configured to cause the apparatus to:
receive, from a station, a request for an update to the second beacon interval, the first frame being transmitted in accordance with receipt of the request.

8. The apparatus of claim 1, wherein the AP is associated with a first link of a multi-link device (MLD), and the first frame further comprises a third indication of an update to a third beacon interval associated with a second link of the MLD.

9. The apparatus of claim 1, wherein the processing system is further configured to cause the apparatus to:
receive a probe request from a station while the access point has suspended beacon frame generation; and
resume beacon frame generation in accordance with receipt of the probe request, the first frame being transmitted in accordance with receipt of the probe request.

10. The apparatus of claim 1, wherein the first frame further comprises an indication of an update to a beacon transmission period associated with the second beacon interval.

11. A method for wireless communication at an access point (AP), comprising:
transmitting a first frame comprising a first indication of a first beacon interval and a second indication of a second beacon interval;
transmitting a second frame at a first time associated with the first indication; and
transmitting a third frame at a second time associated with the second indication.

12. The method of claim 11, wherein the first indication comprises a static beacon interval indication and the second indication comprises a dynamic beacon interval indication.

13. The method of claim 11, wherein the second indication comprises an indication of a multiple of the first beacon interval.

14. The method of claim 11, wherein the first frame further comprises a third indication of an update to the second beacon interval.

15. The method of claim 14, wherein the third indication comprises a counter associated with the update to the second beacon interval, the counter indicating a time for transmission of a fourth frame associated with the update to the second beacon interval.

16. The method of claim 14, further comprising:
receiving a fifth frame from a station indicating a request to cancel the update to the second beacon interval; and
refraining from updating the second beacon interval in association with the request.

17. An apparatus for wireless communications at a station, comprising:
a processing system that includes processor circuitry and memory circuitry that stores code, the processing system configured to cause the apparatus to:
receive, from an access point, a first frame comprising a first indication of a first beacon interval and a second indication of a second beacon interval; and
receive, from the access point, a second frame at a first time associated with the second indication.

18. The apparatus of claim 17, wherein the first indication comprises a static beacon interval indication and the second indication comprises dynamic beacon interval indication.

19. The apparatus of claim 17, wherein the first frame further comprises a third indication of an update to the second beacon interval, the third indication comprises a counter associated with the update to the second beacon interval, and the counter indicates a time for reception of a third frame associated with the update to the second beacon interval, from the access point.

20. The apparatus of claim 19, wherein the processing system is further configured to cause the apparatus to:
transmit, to the access point, a fifth frame indicating a request to cancel the update to the second beacon interval.

21. The apparatus of claim 17, wherein the processing system is further configured to cause the apparatus to:
transmit, to the access point, a request for an update to the second beacon interval, the first frame being received in accordance with receipt of the request by the access point.

22. The apparatus of claim 17, wherein the first frame further comprises an indication of an update to a beacon transmission period associated with the second beacon interval, and the processing system is further configured to cause the apparatus to:
enter a low power state after the beacon transmission period has expired following a time associated with the second indication without receipt of a third frame associated with the second indication.

23. The apparatus of claim 17, wherein the processing system is further configured to cause the apparatus to:
refrain from performing passive scanning during a first time period;
determine a distance between the station and the access point is below a threshold distance; and
transmit, to the access point after the first time period, a third frame in accordance with the determination that the distance between the station and the access point is below the threshold distance, the first frame being received in accordance with the third frame.

24. A method for wireless communication at a station, comprising:
receiving, from an access point, a first frame comprising a first indication of a first beacon interval and a second indication of a second beacon interval; and
receiving, from the access point, a second frame at a first time associated with the second indication.

25. The method of claim 24, wherein the first indication comprises a static beacon interval indication and the second indication comprises dynamic beacon interval indication.

26. The method of claim 24, wherein the first frame further comprises a third indication of an update to the second beacon interval, the third indication comprises a counter associated with the update to the second beacon interval, and the counter indicates a time for reception of a third frame associated with the update to the second beacon interval, from the access point.

27. The method of claim 26, further comprising:
transmitting, to the access point, a fifth frame indicating a request to cancel the update to the second beacon interval.

28. The method of claim 24, further comprising:
transmitting, to the access point, a request for an update to the second beacon interval, the first frame being received in accordance with receipt of the request by the access point.

29. The method of claim 24, wherein the first frame further comprises an indication of an update to a beacon transmission period associated with the second beacon interval, further comprising:
entering a low power state after the beacon transmission period has expired following a time associated with the second indication without receipt of a third frame associated with the second indication.

30. The method of claim 24, further comprising:
refraining from performing passive scanning during a first time period;
determining a distance between the station and the access point is below a threshold distance; and
transmitting, to the access point after the first time period, a third frame in accordance with the determination that the distance between the station and the access point is below the threshold distance, the first frame being received in accordance with the third frame.
